(19) United States
(12) Patent Application Publication
(10) Pub. No.: US 2005/0243027 A1
(43) Pub. Date: Nov. 3, 2005

(54) Plasma display panel and driving method therefor

(76) Inventors: Woo-Joon Chung, Suwon-si (KR); Jin-Sung Kim, Suwon-si (KR); Seung-Hun Chae, Suwon-si (KR); Tae-Seong Kim, Suwon-si (KR); Jin-Ho Yang, Suwon-si (KR)

Correspondence Address: CHRISTIE, PARKER & HALE, LLP, PO BOX 7068, PASADENA, CA, 91109-7068, US

(21) Appl. No.: 11/116,694

(22) Filed: Apr. 27, 2005

(30) Foreign Application Priority Data
Apr. 29, 2004 (KR) 10-2004-0029931

(51) Int. Cl. G09G 3/28

(52) U.S. Cl. 345/60

(57) ABSTRACT

A method for driving a plasma display panel. In the method, a gradually rising ramp voltage is applied in the reset period, and a final voltage of a falling ramp voltage is reduced to generate discharges in discharge cells. A difference between voltages applied to an address electrode and a scan electrode in a discharge cell to be selected is established to be greater than a maximum discharge firing voltage. Positive wall charges and negative wall charges are respectively accumulated in the scan electrode and the sustain electrode by applying the falling ramp voltage while the sustain electrode is biased at a predetermined voltage before the reset period.

### CROSS REFERENCE TO RELATED APPLICATION

This application claims priority to and the benefit of Korean Patent Application No. 10-2004-0029931 filed on Apr. 29, 2004 at the Korean Intellectual Property Office, the entire content of which is incorporated herein by reference.

### BACKGROUND OF THE INVENTION

1. Field of the Invention

The present invention relates to plasma displays, and more particularly, to a method for driving a plasma display panel (PDP).

2. Discussion of the Related Art

A PDP is a flat panel display for showing characters or images using plasma generated by gas discharge, and includes more than hundreds of thousands to millions of pixels arranged in a matrix format, in which the number of pixels are determined by the size of the plasma display panel. A configuration of a conventional PDP will be described with reference to FIG. 1 and FIG. 2.

FIG. 1 shows a partial perspective view of a PDP, and FIG. 2 shows an electrode arrangement of the PDP of FIG. 1. The PDP includes two glass substrates 1, 6 facing each other with a gap therebetween. Pairs of scan electrodes 4 and sustain electrodes 5 are formed in parallel on a first glass substrate 1, and the scan electrodes 4 and the sustain electrodes 5 are covered with a dielectric layer 2 and a protection film 3. A plurality of address electrodes 8 is formed on the glass substrate 6, and the address electrodes 8 are covered with an insulator layer 7. Barrier ribs 9 are formed in parallel with the address electrode 8 on the insulator layer 7 between the address electrodes 8, and phosphors 10 are formed on the surface of the insulator layer 7 and on both sides of the barrier ribs 9. The glass substrates 1, 6 are provided facing each other with discharge spaces 11 between the glass substrates 1, 6 so that the scan electrodes 4 and the sustain electrodes 5 can cross the address electrodes 8. A discharge space 11 between an address electrode 8 and a crossing part of a pair of a scan electrode 4 and a sustain electrode 5 forms a discharge cell 12.

As shown in FIG. 2, the electrodes of the PDP have an m×n matrix format. The address electrodes A1 to Am are arranged in a column direction, and n scan electrodes Y1 to Yn and sustain electrodes X1 to Xn are arranged in a row direction, alternately. A scan/sustain driving circuit 20 is coupled to the scan electrodes Y1 to Yn and the sustain electrodes X1 to Xn, and an address driving circuit 30 is coupled to the address electrodes A1 to Am.

Published U.S. Pat. Application No. 6,294,875 by Kurata discloses a method for driving the conventional plasma display panel. A field is divided into eight subfields, and a waveform applied in the reset period of a first subfield is established to be varied from waveforms applied in second to eighth subfield reset periods.

As shown in FIG. 3, each subfield has a reset period, an address period, and a sustain period. In the reset period of the first subfield, a ramp voltage gradually rising from a voltage Vp which is less than a discharge firing voltage to a voltage Vr which is greater than the discharge firing voltage is applied to the scan electrodes Y1 to Yn. While the ramp voltage is increased, a weak discharge is respectively generated from the scan electrodes Y1 to Yn to the address electrodes A1 to Am and the sustain electrodes X1 to Xn. Negative wall charges are accumulated in the scan electrodes Y1 to Yn, and positive wall charges are accumulated in the address electrodes A1 to Am and the sustain electrodes X1 to Xn by the discharge. Referring back to FIG. 1, the wall charges are formed on a surface of the protection film 3 of the scan electrode 4 and the sustain electrode 5. However, for convenience of description, the wall charges will be deemed to be formed on the scan electrode 4 and on the sustain electrode 5.

A ramp voltage gradually falling from a voltage Vq which is less than the discharge firing voltage to 0V is applied to the scan electrodes Y1 to Yn. While the ramp voltage is reduced, a weak discharge is generated from the sustain electrodes X1 to Xn and the address electrodes A1 to Am to the scan electrodes Y1 to Yn by a wall voltage formed in the discharge cell. Some of the wall charges formed in the sustain electrodes X1 to Xn and the scan electrodes Y1 to Yn are eliminated by the discharge, and therefore a proper state for an address operation is provided. The wall charges are formed on a surface of the insulator layer 7 of the address electrode 8. However, also for convenience of description, the wall charges will be deemed to be formed on the address electrode 8.

A positive voltage Va is applied to the address electrodes A1 to Am, and 0V is applied to the scan electrodes Y1 to Yn of the discharge cell to be selected in the address period. An address discharge is generated between the address electrodes A1 to Am and the scan electrodes Y1 to Yn, and between the sustain electrodes X1 to Xn and the scan electrodes Y1 to Yn, by the positive voltage Va and the wall voltage caused by the wall charges formed in the reset period. The positive wall charges are accumulated in the scan electrodes Y1 to Yn, and the negative wall charges are accumulated in the sustain electrodes X1 to Xn and the address electrodes A1 to Am by the discharge. A sustain discharge is generated by a sustain pulse applied in the sustain period of the discharge cell having the wall charges accumulated by the address discharge.

A voltage level of a last sustain pulse applied to the scan electrodes Y1 to Yn in the sustain period of the first subfield corresponds to a voltage Vr of the reset period, and a voltage (Vr−Vs) corresponding to a difference between the voltage Vr and a sustain voltage Vs is applied to the sustain electrodes X1 to Xn. A discharge is generated from the scan electrodes Y1 to Yn to the address electrodes A1 to Am, and the sustain discharge is generated from the scan electrodes Y1 to Yn to the sustain electrodes X1 to Xn in the discharge cell selected in the address period by the wall voltage formed by the address discharge. The discharge corresponds to the discharge generated by a rising ramp voltage in the reset period of the first subfield. No discharge is generated in the discharge cell which is not selected because no address discharge has been generated.

In a reset period of a second subfield, a voltage Vh is applied to the sustain electrodes X1 to Xn, and a ramp voltage gradually falling from the voltage Vq to 0V is applied to the scan electrodes Y1 to Yn. That is, a voltage corresponding to the falling ramp voltage applied in the reset period of the first subfield is applied to the scan electrodes Y1 to Yn. A weak discharge is generated in the selected discharge cell and no discharge is generated in the discharge cell which is not selected in the first subfield.

In reset periods of the other succeeding subfields, a waveform corresponding to the waveform in the reset period of the second subfield is applied. In an eighth subfield, an erasing period is formed after a sustain period. In the erasing period, a ramp voltage gradually rising from 0V to a voltage Ve is applied to the sustain electrodes X1 to Xn. The wall charges formed in the discharge cell are eliminated by the ramp voltage.

In the conventional driving waveform, the reset discharge is performed in the reset period for a cell performing the sustain discharge in a previous subfield from the second subfield. However, a wall charge loss is frequently generated by crosstalk caused by discharges of neighboring cells and a spontaneous extinction of the wall charges by an internal field in the cell where no sustain discharge is generated after the reset period. It is impossible to rearrange the wall charges by the reset waveform of the reset waveforms from the second subfield according to the conventional manner as described above, and therefore an address operation is not properly performed in the address period. Also, when the reset waveform of the first subfield shown in FIG. 3 is applied, brightness quality gets worse and time for a reset operation is increased.

### SUMMARY OF THE INVENTION

The present invention provides a method for driving a plasma display panel for performing an address operation without using an internal wall voltage.

The present invention also provides a method for driving a plasma display panel for eliminating a strong discharge generated in the reset period in the method for driving the plasma display panel for performing the address operation without using an internal wall voltage.

The present invention further discloses a method for driving a plasma display panel having a plurality of first electrodes and a plurality of second electrodes arranged on a first substrate in parallel, and a plurality of third electrodes formed on a second substrate crossing the first electrodes and the second electrodes, wherein discharge cells are formed by the neighboring first electrodes, second electrodes, and third electrodes.

In the method, a) a voltage obtained by subtracting a voltage at the second electrode from a voltage at the first electrode is gradually reduced from a first voltage to a second voltage; b) a gradually rising voltage is applied to the first electrode; and c) the voltage obtained by subtracting the voltage at the second electrode from the voltage at the first electrode is gradually reduced from a third voltage to a fourth voltage.

The second voltage is substantially less than the fourth voltage. In an address period, a eleventh voltage and a twelfth voltage are respectively applied to the third electrode and the first electrode in a discharge cell to be selected among the discharge cells; and in a sustain period, the discharge cell selected in the address period is sustain-discharged. In c), a voltage obtained by subtracting a voltage at the third electrode from the voltage at the first electrode is gradually reduced from a thirteenth voltage to a fourteenth voltage, and the fourteenth voltage is substantially less than a negative value of a voltage corresponding to a half value of the difference between the voltages applied to the first electrode and the second electrode for sustain-discharging in the sustain period. The fourteenth voltage is substantially less than a negative value of a voltage corresponding to the difference between the voltages applied to the first electrode and the second electrode for sustain-discharging in the sustain period.

The present invention also discloses a plasma display having a first substrate, a plurality of first electrodes, and a plurality of second electrodes formed on the first substrate in parallel, a second substrate facing the first substrate with a gap therebetween, a plurality of third electrodes formed on the second substrate crossing the first electrodes and the second electrodes, and a driving circuit for supplying a driving voltage to the first electrode, second electrode, and the third electrode in order to discharge a discharge cell formed by the first electrode, the second electrode, and the third electrode neighboring each other.

The driving circuit gradually reduces a voltage obtained by subtracting a voltage at the second electrode from a voltage at the first electrode from a first voltage to a second voltage, applies a gradually rising voltage to the first electrode, and gradually reduces the voltage obtained by subtracting the voltage at the second electrode from the voltage at the first electrode from a third voltage to a fourth voltage.

The second voltage is substantially less than the fourth voltage. The driving circuit discharges a discharge cell to be selected among the discharge cells in an address period, and sustain-discharges the selected cell in the sustain period, a voltage obtained by subtracting a voltage at the third electrode from a voltage at the first electrode is substantially reduced from a fifth voltage to a sixth voltage while the voltage obtained by subtracting the voltage at the second electrode from the voltage at the first electrode is gradually reduced from the third voltage to the fourth voltage, and the sixth voltage is substantially less than a negative value of a voltage corresponding to a half value of a difference between voltages applied to the first electrode and the second electrode for sustain-discharging in the sustain period. The sixth voltage is substantially less than a negative value of a voltage corresponding to the difference between the voltages applied to the first electrode and the second electrode for sustain-discharging in the sustain period.

### BRIEF DESCRIPTION OF THE DRAWINGS

FIG. 1 shows a partial perspective view of a conventional plasma display panel.

FIG. 2 shows electrode arrangements of a conventional plasma display panel.

FIG. 3 shows conventional driving waveforms for a conventional plasma display panel.

FIG. 4 shows driving waveforms of a plasma display panel according to a first exemplary embodiment of the present invention.

FIG. 5 shows the relationship between a falling ramp voltage and a wall voltage when the falling ramp voltage is applied to discharge cells.

FIG. 6 shows driving waveforms of a plasma display panel according to a second exemplary of the present invention.

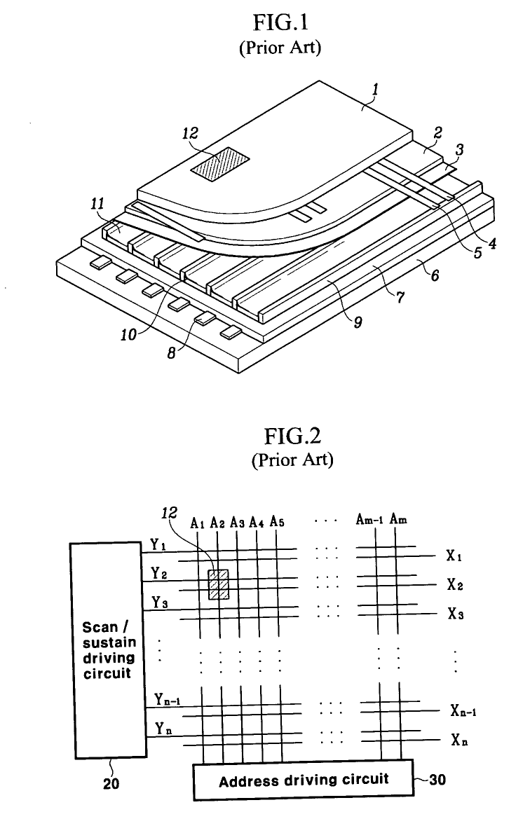

### DETAILED DESCRIPTION

A method for driving a plasma display panel according to a first exemplary embodiment of the present invention will now be described with reference to FIG. 4 wherein address electrodes, scan electrodes, and sustain electrodes are respectively denoted by A, Y, and X. A voltage is applied to the address electrodes, scan electrodes, and the sustain electrodes. When the address electrode and the scan electrode are respectively denoted by Ai and Yi, a corresponding voltage is applied to an address electrode and a scan electrode.

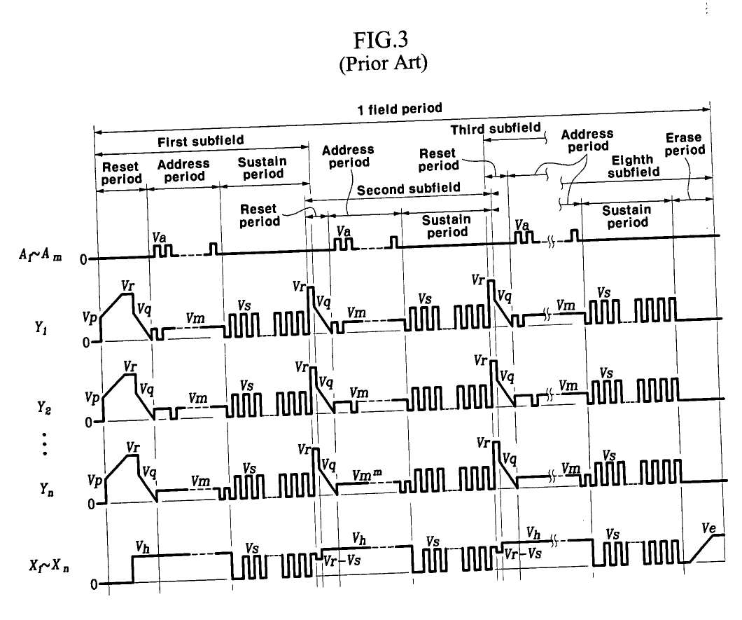

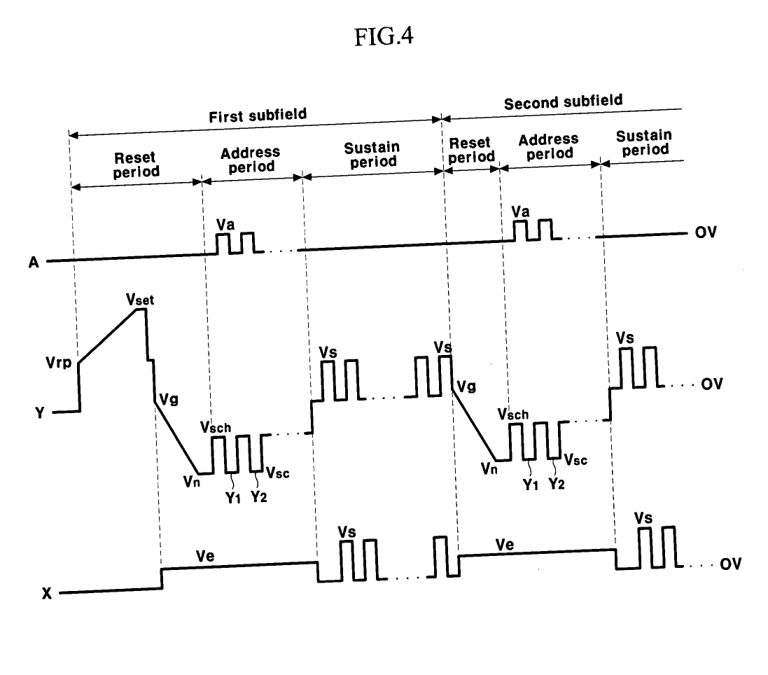

As shown in FIG. 4, a waveform according to a first exemplary embodiment of the present invention has a reset period, an address period, and a sustain period. The plasma display panel is coupled to a scan/sustain driving circuit (20 in FIG. 2) for applying driving voltages to the sustain electrodes Y1 to Yn and the sustain electrodes X1 to Xn and an address driving circuit (30 in FIG. 2) for applying a driving voltage to the address electrodes A1 to Am. The driving circuits and the plasma display panel are coupled to each other to thus form a plasma display.

In the reset period of a first subfield, a ramp voltage gradually rising from a voltage Vrp, which is less than a discharge firing voltage, to a voltage Vset, which is greater than the discharge firing voltage, is applied to the scan electrodes Y. A weak discharge is generated from the scan electrodes Y to the address electrodes A and the sustain electrodes X while the ramp voltage is applied. Negative (−) wall charges are accumulated to the scan electrodes Y and positive (+) wall charges are accumulated to the address electrodes A and the sustain electrodes X by the discharge.

A ramp voltage gradually falling from a voltage Vg to a voltage Vn is applied to the scan electrodes Y. At the onset of the gradually falling ramp voltage, the sustain electrodes X are biased at a voltage Ve. A reference voltage (0V in FIG. 4) is maintained at the address electrodes A. The voltage Vn of the falling ramp voltage corresponds to a voltage −Vfay when a discharge firing voltage between the address electrode and the scan electrode in the discharge cell is assumed to be a voltage Vfay.

A discharge is generated between the scan electrode and the address electrode or between the scan electrode and the sustain electrode when a voltage between the scan electrode and the address electrode or between the scan electrode and the sustain electrode is greater than the discharge firing voltage. When a discharge is generated by applying the gradually falling ramp voltage as shown in the first exemplary embodiment of the present invention, a wall voltage in the discharge cell is reduced at a speed corresponding to the falling ramp voltage. Published U.S. Patent Application No. 5,745,086 discloses such, and, therefore, a detailed description thereof will be omitted.

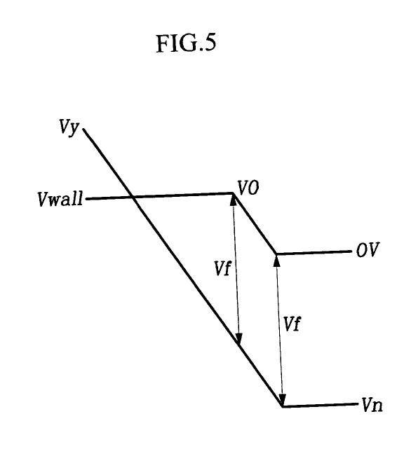

Discharge characteristics when applying a ramp voltage falling to the voltage −Vfay will now be described referring to FIG. 5 which shows the relationship between the falling ramp voltage and the wall voltage when the falling ramp voltage is applied to the discharge cell. Descriptions involving FIG. 5 will focus on the scan electrode and the address electrode, and it is assumed that the negative wall charges and the positive wall charges are respectively accumulated to the scan electrode and the address electrode, and therefore a predetermined amount of wall voltage V0 is formed when the falling ramp voltage is applied.

As shown in FIG. 5, a discharge is generated when a difference between a wall voltage Vwall and a voltage Vy applied to the scan electrode is greater than the discharge firing voltage Vfay while the voltage applied to the scan electrode is gradually reduced. Accordingly, the wall voltage Vwall in the discharge cell is reduced at a speed corresponding to the falling ramp voltage Vy. The difference between the falling ramp voltage Vy and the wall voltage Vwall is maintained at the discharge firing voltage Vfay. Therefore, as shown in FIG. 5, the wall voltage Vwall between the address electrode and the scan electrode in the discharge cell becomes 0V when the voltage Vy applied to the scan electrode is reduced from the voltage −Vfay (−Vf voltage).

The voltage Vy applied to the scan electrode in the first exemplary embodiment of the present invention is established to be enough to generate a discharge from the address electrodes A to the scan electrodes Y in the discharge cells. The respective discharge cells include a discharge cell having an area for effectively displaying (an effective display area) an image on a screen of the plasma display panel.

As shown in Equation 1 below, a difference V_{A-Y,reset} between 0V applied to the address electrodes A and a voltage Vn applied to the scan electrodes is established to be greater than a discharge firing voltage V_{f,MAX} of the cell having the maximum discharge firing voltage among the discharge cells. A negative wall voltage is formed when the voltage |Vn| is greater than the maximum discharge firing voltage V_{f,MAX}, and therefore the voltage |Vn| corresponds to the maximum discharge firing voltage V_{f,MAX}.
V_{A-Y,reset}=|Vn|>=V_{f,MAX} [Equation 1]

As shown, the wall charges are eliminated in the discharge cells when the ramp voltage falling to the voltage Vn is applied to the scan electrodes Y. The negative (−) voltage is generated in the discharge cell having a discharge firing voltage Vf which is less than the maximum discharge firing voltage V_{f,MAX} when the voltage |Vn| is established to be the maximum discharge firing voltage V_{f,MAX}. That is, the negative (−) wall charges are generated in the address electrodes A. The generated wall voltage eliminates disparity between the discharge cells in the address period.

Referring back to FIG. 4, the scan electrodes Y and the sustain electrodes X are respectively maintained at a voltage Vsch and a voltage Ve, and a voltage is applied to the scan electrodes Y and the address electrodes A for selecting the discharge cell to be displayed. That is, a negative voltage Vsc is applied to a first row of the scan electrode Y1, and a positive voltage Va is applied to the address electrode Ai in the discharge cell to be displayed among the first row at the same time. The voltage Vsc is established to correspond to the voltage Vn in the reset period.

A voltage difference (V_{A-Y,address}) between the address electrode Ai and the scan electrode Y1 in the discharge cell selected in the address period is greater than the maximum discharge firing voltage V_{f,MAX} as shown in Equation 2 below.
V_{A-Y,address}=V_{A-Y,reset}+V_{W}>V_{f,MAX} [Equation 2]

Accordingly, an address discharge is generated between the address electrode Ai and the scan electrode Y1, and between the sustain electrode Xl and the scan electrode Y1 in the discharge cell formed by the address electrode Ai to which the voltage Va is applied and the scan electrode Y1 to which the voltage Vsc is applied. As a result, the positive (+) wall charges are formed in the scan electrode Y1 and the negative (−) wall charges are formed in the sustain electrode X1. The negative (−) wall charges are also formed in the address electrode Ai.

The voltage Va is applied to the address electrode Ai in the discharge cell to be displayed in a second row while the voltage Vsc is applied to the scan electrode Y2 in the second row. The address discharge is generated in the discharge cell formed by the address electrode Ai to which the voltage Va is applied and the scan electrode Y2 to which the voltage Vsc is applied, and therefore the wall charges are formed in the discharge cell. The voltage Va is applied to the address electrode in the discharge cell to be displayed while the voltage Vsc is sequentially applied to the other scan electrodes Y3 to Yn, and therefore the wall charges are formed.

The reference voltage 0V is applied to the sustain electrodes X while the voltage Vs is applied to the scan electrodes Y in the sustain period. In the discharge cell selected in the address period, a voltage between the scan electrode Yj and the sustain electrode Xj corresponds to a sum of the voltage Vs and the wall voltage caused by the positive (+) wall charges of the scan electrode Yj and the negative (−) wall charges of the sustain electrode Xj, and therefore the voltage is greater than the discharge firing voltage Vfxy between the scan electrode and the sustain electrode. Accordingly, a sustain-discharge is generated between the scan electrode Yj and the sustain electrode Xj. The negative (−) wall charges and the positive (+) wall charges are respectively formed in the scan electrode Yj and the sustain electrode Xj in the discharge cell which is sustain-discharged.

0V is applied to the scan electrodes Y and the voltage Vs is applied to the sustain electrodes X. In the discharge cell which is previously sustain-discharged, the voltage between the sustain electrode Xj and the scan electrode Yj corresponds to a sum of the voltage Vs and the wall voltage caused by the positive (+) wall charges of the sustain electrode Xj and the negative (−) wall charges of the scan electrode Yj, and therefore the voltage is greater than the discharge firing voltage Vfxy. Accordingly, the sustain-discharge is generated between the scan electrode Yj and the sustain electrode Xj. The positive (+) wall charges and the negative (−) wall charges are respectively formed in the sustain electrode Xj and the scan electrode Yj in the discharge cell which is sustain-discharged.

Correspondingly, the voltage Vs and 0V are alternately applied to the scan electrodes Y and the sustain electrodes X, and the sustain-discharge is continuously performed. In the last sustain pulse of the sustain period, the voltage Vs is applied to the scan electrodes Y and 0V is applied to the sustain electrodes X. A discharge is generated from the scan electrode Yj to the sustain electrode Xj in the selected discharge cell, and the negative wall charges and the positive wall charges are respectively formed in the scan electrode Yj and the sustain electrode Xj.

In the reset period of a second subfield, a ramp voltage gradually falling from the voltage Vg to the voltage Vn is applied to the scan electrodes Y after the last sustain pulse applied in the sustain period of the first subfield. The reference voltage 0V is applied to the address electrodes A in the like manner of the reset period of the first subfield, and the sustain electrodes X are biased at the voltage Ve. That is, a voltage corresponding to the falling ramp voltage applied in the reset period of the first subfield is applied to the scan electrodes Y. A weak discharge is generated in the discharge cell selected in the first subfield, and no discharge is generated in the discharge cell which is not selected. The wall charges between the scan electrodes Y and the address electrodes A are eliminated in the reset period of the second subfield in the like manner of the reset period of the first subfield. That is, the weak discharge is generated in the selected cell in the first subfield by the reset period of the second subfield, and therefore the wall charges between the scan electrode and the address electrode are eliminated.

Waveforms applied in the address period and the sustain period of the second subfield correspond to those of the first subfield, and therefore descriptions will be omitted. A waveform corresponding to that of the second subfield is applied in a third to an eighth subfield, and a waveform corresponding to that of the first subfield is applied in a subfield between the third subfield and the eighth subfield.

The relationships of the discharge firing voltage V_{fay} between the address electrode and the scan electrode, the discharge firing voltage V_{fxy} between the sustain electrode and the scan electrode, and the voltage Vs will now be described.

A discharge of the plasma display panel is determined by the quantity of secondary electrons discharged when positive ions collide with a negative electrode, which is referred to as a process. Accordingly, the discharge firing voltage when the electrode covered with a material having a high secondary emission coefficient functions as the negative electrode is less than the discharge firing voltage when the electrode covered with a material having a low secondary emission coefficient functions as the negative electrode. In a three electrode plasma display panel, the address electrode formed on a rear substrate is covered with a phosphor for color representation, and the scan electrode and the sustain electrode formed on a front substrate are covered with a dialectic layer formed out of MgO for a sustain-discharge. The secondary emission coefficient of the dialectic layer formed out of MgO is high, and the secondary emission coefficient of the phosphor layer is low. The scan electrode and the sustain electrode are symmetrically formed. However, the address electrode and the scan electrode are asymmetrically formed, and, therefore, the discharge firing voltage between the address electrode and the scan electrode is varied according to whether the address electrode functions as a positive electrode or as a negative electrode.

That is, a discharge firing voltage Vfay when the address electrode covered with the phosphors functions as the positive electrode and the scan electrode covered with the dialectic layer functions as the negative electrode is less than a discharge firing voltage Vfya when the address electrode functions as the negative electrode and the scan electrode functions as the positive electrode. The relationship set forth in Equation 3 below is established among the discharge firing voltage Vfay when the address electrode is the positive electrode, the discharge firing voltage Vfya when the address electrode is the negative electrode, and the discharge firing voltage Vfxy. The relation may be varied according to the discharge cell state.
V_{fay}+V_{fya}=2V_{fxy} [Equation 3]

The scan electrode functions as the negative electrode in the reset period and the address period, and therefore the discharge firing voltage Vfay between the address electrode and the scan electrode satisfies Equation 4 below derived from a relationship set forth in Equation 3 above. The sustain-discharge is not generated in the discharge cell which is not addressed in the address period, and therefore the voltage Vs is less than the discharge firing voltage Vfxy between the scan electrode and the sustain electrode as shown in Equation 5 below.
V_{fay}<<V_{fxy} [Equation 4]
Vₛ<<V_{fxy} [Equation 5]

The wall voltage between the address electrode and the scan electrode is established to be near 0V in the reset period of the first exemplary embodiment of the present invention. Therefore, in the discharge cell which is not addressed in the address period, discharges are not sequentially generated between the scan electrode and the address electrode, and between the sustain electrode and the address electrode. That is, a sequence discharge is generated when the voltage Vs is applied to the scan electrode, a discharge is generated between the scan electrode and the address electrode, and another discharge is also generated between the sustain electrode and the address electrode when positive wall charges are formed in the address electrode by the discharge (between the scan electrode and the address electrode) and the voltage Vs is applied to the sustain electrode. The sustain electrode and the scan electrode are symmetrical electrodes, and therefore a discharge firing voltage between the sustain electrode and the address electrode corresponds to the voltage Vfay, and a wall voltage formed in the sustain electrode and the address electrode when the positive wall charges are accumulated by the discharge between the scan electrode and the address electrode is not greater than the voltage Vfay. Accordingly, the voltage Vfay is greater than a voltage Vs/2 in order to not generate the discharge when the voltage Vs is applied to the sustain electrode after the positive wall charges are formed in the sustain electrode by the discharge between the scan electrode and the address electrode, which is shown in Equation 6 below.
Vₛ−V_{fay}<V_{fay}
V_{fay}>Vₛ/2 [Equation 6]

In Equation 4 to Equation 6, the voltage Vfay is established to be greater than the voltage Vs/2, and is determined to be around the voltage Vs because the voltage Vfay and the voltage Vs are less than the voltage Vfxy by a predetermined voltage. That is, the relationship set forth in Equation 7 below is established. A voltage ΔV has a value between 0V and 30V.
Vₛ/2<V_{fay}=Vₛ±ΔV [Equation 7]

In FIG. 4, a voltage Ve applied to the sustain electrodes X1 to Xn in the reset period and the address period is represented as a positive voltage. The voltage Ve may be varied when the discharge is generated between the scan electrode Yi and the sustain electrode Xi by the discharge between the scan electrode Yi and the address electrode Ai. For example, the voltage Ve may be 0V or a negative voltage.

According to the first exemplary embodiment of the present invention, a voltage difference between the address electrode and the scan electrode in the cell to be displayed in the address period is established to be greater than the maximum discharge firing voltage, and therefore an address discharge is generated although the wall charges are not generated in the reset period. Therefore, a worse margin caused by the wall charge loss is eliminated because the address discharge is not affected by the wall charges formed in the reset period.

The voltage difference between the address electrodes A and the scan electrodes Y is greater than the maximum discharge firing voltage over the voltage Va, and therefore the address discharge is generated regardless of the wall charges.

The sustain electrodes X are biased at the voltage Ve while a ramp voltage gradually falling from the voltage Vg to the voltage Vn is applied to the scan electrodes Y in the reset period. The voltage Ve is properly selected to establish the wall voltage between the scan electrodes Y and the sustain electrodes Y to be 0V after the reset period. Accordingly, the wall voltage between the scan electrodes Y and the sustain electrodes X is established to be 0V after the falling ramp voltage is applied in the reset period. As shown in the first exemplary embodiment of the present invention, the wall voltage between the scan electrodes X and the address electrodes A is also 0V, and therefore the wall charges are eliminated.

Accordingly, the wall voltages between the scan electrodes Y and the sustain electrodes X, and between the scan electrodes Y and the address electrodes A become 0V by the waveforms of the reset period in the first exemplary embodiment of the present invention. However, a strong discharge is generated in the subfield to which a ramp voltage gradually rising as the reset waveform of the first subfield shown in FIG. 4 is applied when the wall voltage is 0V. It will now be described why the strong discharge is generated in the reset period having a period for applying the gradually rising ramp voltage when the wall voltage between the scan electrode and the sustain electrode, and between the scan electrode and the address electrode are 0V.

The discharge firing voltage Vfyx between the scan electrodes Y and the sustain electrodes X is greater than the discharge firing voltage Vfya between the scan electrodes Y and the address electrodes A. A weak discharge is generated from the scan electrodes Y to the sustain electrodes X and the address electrodes A when the gradually rising ramp voltage is applied in the reset period of the first subfield shown in FIG. 4. Accordingly, the discharge between the scan electrodes Y and the address electrodes A is generated before the discharge between the scan electrodes Y and the sustain electrodes X when the rising ramp voltage is applied in the reset period of the first subfield because the wall charges between the scan electrodes Y and the sustain electrodes X, and between the scan electrodes Y and the address electrodes A are established to be 0V by the reset waveform after the reset period in the first exemplary embodiment of the present invention, that is, because the wall voltage states correspond to each other.

As described, the discharge on the plasma display panel is determined by the number of the second electrons discharged when the positive (+) ions collide with the negative electrode. Accordingly, it takes a longer time to generate a discharge because the discharge is not properly generated when the electrode covered with a material having a lesser electron coefficient functions as a negative electrode. In the three electrode plasma display panel, the address electrode formed on the rear substrate is covered with a phosphor for representing colors, and the scan electrode and the sustain electrode formed on the front substrate are covered with a dialectic layer formed of MgO for sustain-discharging. The dialectic layer formed of MgO has a higher secondary emission coefficient. The phosphor layer has a lesser secondary emission coefficient. Accordingly, a discharge is first generated when the rising ramp voltage in the reset period is applied because the discharge firing voltage between the scan electrodes Y and the address electrodes A is less (because the wall charges between the scan electrode and the address electrode, and between the scan electrode and the sustain electrode are 0V). However, the discharge is not properly generated because the address electrodes A are covered with the phosphor function as the negative electrode, and therefore the discharge is delayed and generated at a value over a predetermined threshold value. However, a point of time for generating the discharge between the scan electrodes Y and the address electrodes A has been over the discharge firing voltage between the scan electrodes Y and the address electrodes A, and therefore the strong discharge is problematically generated.

That is, the strong discharge is generated because the discharge between the scan electrodes Y and the address electrodes A is generated before the discharge between the scan electrodes Y and the sustain electrodes when the rising ramp voltage as the reset waveform in the first subfield is applied to the cell which is not selected (the wall charge state is maintained in the reset period of the cell which is not selected) in the address period after the reset period as shown in FIG. 4. In other words, the strong discharge is problematically generated because the discharge is generated first between the scan electrode and the address electrode in the rising ramp waveform of the reset period of the first subfield when the wall voltages between the scan electrode and the address electrode, and between the scan electrode and the sustain electrode are established to be 0V.

A method for eliminating the strong discharge generated in the first exemplary embodiment of the present invention will now be described, wherein the discharge is first generated between the scan electrodes Y and the sustain electrodes X before the rising ramp waveform in the reset period is applied.

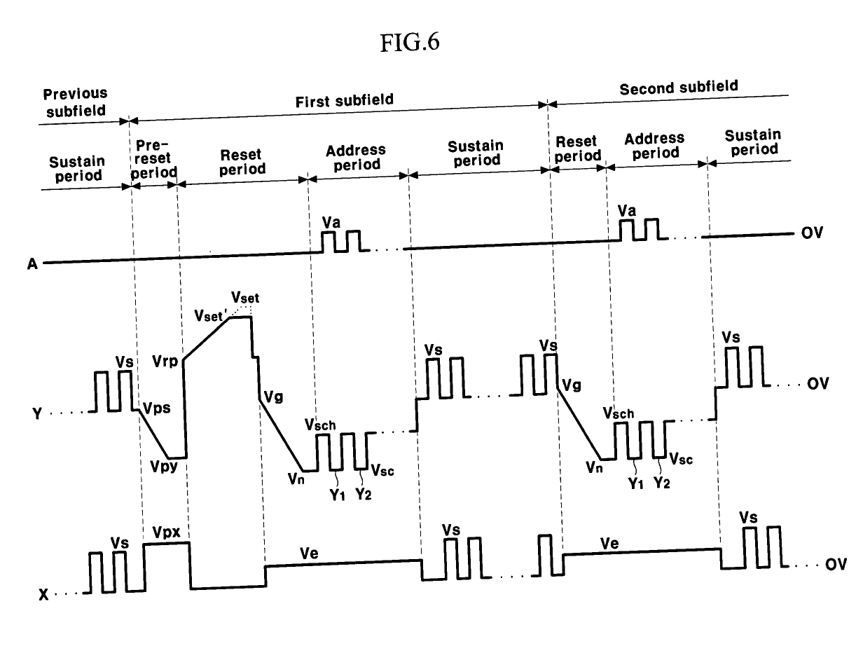

As shown in FIG. 6, in driving waveforms according to a second exemplary embodiment of the present invention, a period (hereinafter referred to as a pre-reset period) for forming the wall voltage between the scan electrodes Y and the sustain electrodes X is provided before the reset period having a period for applying the gradually rising ramp voltage. A method for driving the plasma display panel according to the second exemplary embodiment of the present invention corresponds to that of the first exemplary embodiment of the present invention except having the pre-reset period, and therefore repeated descriptions will be omitted.

In the pre-reset period, a ramp voltage gradually falling from a voltage Vps to a voltage Vpy is applied to the scan electrodes Y before a gradually rising ramp voltage is applied to the scan electrodes Y. A reference voltage 0V is applied to the address electrodes A, and the sustain electrodes X are biased at a voltage Vpx. As will be shown in Equation 8 below, a difference between the voltage Vpx and the voltage Vpy is greater than a difference between the voltage Vn and the voltage Ve in order to form positive (+) wall charges in the scan electrodes Y and negative (−) wall charges in the sustain electrodes X.
|Vpx−Vpy|>|Vn−Ve| [Equation 8]

That is, the wall voltage is established to be near 0V when the voltage Vn and the voltage Ve are applied (the voltage Vn is applied to the scan electrode and the voltage Ve is applied to the sustain electrode when the falling ramp voltage is applied in the reset period), and therefore the voltage difference is established to be greater than the difference between the voltage Vn and the voltage Ve in the pre-reset period. That is, it is established as shown in Equation 8, and therefore the positive wall charges are formed in the scan electrodes Y and the negative wall charges are formed in the sustain electrodes X. The voltage Vpy and the voltage Ve are established to correspond to each other, and the voltage Vpx is established to be greater than the voltage Ve for the purpose of controlling the wall charges between the scan electrodes Y and the sustain electrodes X in the pre-reset period.

The wall voltage between the scan electrodes Y and the sustain electrodes X becomes 0V by applying the waveform of the reset period in a previous subfield as shown in FIG. 4. In the discharge cell which is not selected in the address period, a weak discharge is generated from the sustain electrodes X to the scan electrodes Y at a point where the difference between the scan electrode and the sustain electrode exceeds the discharge firing voltage in the pre-reset period. The positive (+) wall charges are formed in the scan electrodes Y and the negative (−) wall charges are formed in the sustain electrodes X by the weak discharge. The difference between the voltage Vpy applied to the scan electrodes Y and the voltage Vpx applied to the sustain electrodes X is greater than the difference between the voltage Vn applied to the scan electrodes Y and the voltage Ve applied to the sustain electrodes X when the falling ramp voltage of the reset period is applied for the purpose of generating the discharge when the voltage difference between the scan electrodes Y and the sustain electrodes Y exceeds the discharge firing voltage.

The wall voltage between the scan electrodes Y and the sustain electrodes X becomes 0V by applying the waveform of the reset period in a previous subfield as shown in FIG. 4. In the discharge cell which is not selected in the address period, no discharge is generated because the address electrode is biased at the reference voltage 0V and therefore the difference between the scan electrode and the address electrode A does not exceed the discharge firing voltage. That is, the discharge is not generated because the voltage difference between the scan electrodes and the address electrodes A when applying the falling waveform of the reset waveform is less than the voltage difference between the scan electrodes Y and the address electrodes A in the pre-reset period.

As shown, the pre-reset period is provided before the reset period in which the gradually rising ramp waveform is applied, and therefore the discharge between the scan electrodes Y and the sustain electrodes X is established to be generated before the discharge between the scan electrodes Y and the address electrodes A in the reset period by the positive (+) wall charges formed in the scan electrodes Y and the negative wall charges formed in the sustain electrodes X. The voltage Vset is established to be a voltage Vset′ which is less than the voltage Vset of the reset period according to the first exemplary embodiment of the present invention because the discharge is quickly generated by respectively forming the positive and the negative wall charges in the scan electrodes Y and the sustain electrodes X in the pre-reset period.

The wall voltage formed between the scan electrodes Y and the sustain electrodes X in the pre-reset period is established to be added to the voltage Vrp applied in the reset period and to not generate the strong discharge.

While the voltage Vpx is varied from the voltage Vs in FIG. 6, the voltage Vpx is established to correspond to the voltage Vs in order to reduce the number of power sources, and the voltage Vrp also is established to correspond to the voltage Vs in order to reduce the number of power sources. Also, the voltage Vps is established to correspond to the voltage Vq. The voltage Vpy is properly established to satisfy Equation 8. The voltage Vpy is established to not generate the strong discharge by a sum of the voltage Vrp and the wall voltage between the sustain electrode and the scan electrode formed in the pre-reset period.

While the pre-reset period is provided before the reset period when the wall voltages are eliminated in the reset period in the like manner of the first exemplary embodiment of the present invention, the strong discharge in the reset period is eliminated by providing the pre-reset period as shown in FIG. 6. The discharge between the scan electrode and the sustain electrode is generated in the pre-reset period before the discharge between the scan electrode and the address electrode is generated in the reset period.

While the voltage applied to the address electrode in the pre-reset period and the reset period is established to be 0V in the exemplary embodiments of the present invention, the voltages applied to the address electrode and the scan electrode are established to be varied when the difference between the voltages applied to the address electrode and the scan electrode satisfies the relations in the exemplary embodiments of the present invention because the wall voltage between the address electrode and the scan electrode is determined by the difference between the voltages applied to the address electrode and the scan electrode.

While ramp style voltages are applied to the scan electrode in the pre-reset period and the reset period in the exemplary embodiments of the present invention, other styles of voltages for generating the weak discharge and controlling the wall charges are applied to the scan electrode, and a level of the voltages is gradually varied according to time variation.

As shown, the problem of a margin reduced by the wall charge loss is eliminated because the address discharge is not affected by the wall charges formed in the reset period.

The strong discharge is prevented from being generated in the reset period by respectively forming the positive wall charges and the negative wall charges in the scan electrode and the sustain electrode before the reset period having a period gradually rising.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A method for driving a plasma display panel having a plurality of first electrodes and a plurality of second electrodes arranged on a first substrate in parallel, and a plurality of third electrodes crossing the first electrodes and the second electrodes and formed on a second substrate, wherein discharge cells are formed by the first electrodes, second electrodes, and third electrodes neighboring each other, the method comprising:
gradually reducing a voltage obtained by subtracting a voltage at the second electrode from a voltage at the first electrode from a first voltage to a second voltage;
applying a gradually rising voltage to the first electrode; and
gradually reducing the voltage obtained by subtracting the voltage at the second electrode from the voltage at the first electrode from a third voltage to a fourth voltage,
wherein the second voltage is substantially less than the fourth voltage.

2. The method of claim 1, wherein a voltage gradually falling from a sixth voltage to a seventh voltage is applied to the first electrode while the second electrode is biased at a fifth voltage when gradually reducing a voltage obtained by subtracting a voltage at the second electrode from a voltage at the first electrode from a first voltage to a second voltage, and a voltage gradually falling from a ninth voltage to a tenth voltage is applied to the first electrode while the second electrode is biased at an eighth voltage when gradually reducing the voltage obtained by subtracting the voltage at the second electrode from the voltage at the first electrode from a third voltage to a fourth voltage.

3. The method of claim 2, wherein a difference between the fifth voltage and the seventh voltage is substantially greater than a difference between the eighth voltage and the tenth voltage.

4. The method of claim 1, further comprising:
in an address period, respectively applying an eleventh voltage and a twelfth voltage to the third electrode and the first electrode in a discharge cell to be selected among the discharge cells; and
in a sustain period, sustain-discharging the discharge cell selected in the address period, and
wherein, when gradually reducing the voltage obtained by subtracting the voltage at the second electrode from the voltage at the first electrode from a third voltage to a fourth voltage, a voltage obtained by subtracting a voltage at the third electrode from the voltage at the first electrode is gradually reduced from a thirteenth voltage to a fourteenth voltage, and the fourteenth voltage is substantially less than a negative value of a voltage corresponding to a half value of the difference between the voltages applied to the first electrode and the second electrode for sustain-discharging in the sustain period.

5. The method of claim 4, wherein the fourteenth voltage is substantially less than a negative value of a voltage corresponding to the difference between the voltages applied to the first electrode and the second electrode for sustain-discharging in the sustain period.

6. The method of claim 4, wherein the fourteenth voltage is substantially less than a negative value of a discharge firing voltage between the first electrode and the third electrode.

7. The method of claim 6, wherein the discharge firing voltage generates a discharge when substantially no wall charge is formed in the discharge cell.

8. The method of claim 6, wherein, when gradually reducing the voltage obtained by subtracting the voltage at the second electrode from the voltage at the first electrode from a third voltage to a fourth voltage, a wall voltage between the first electrode and the third electrode is substantially eliminated.

9. The method of claim 2, wherein the seventh voltage substantially corresponds to the tenth voltage and the fifth voltage is substantially greater than the eighth voltage.

10. The method of claim 1, wherein applying a gradually rising voltage to the first electrode and gradually reducing the voltage obtained by subtracting the voltage at the second electrode from the voltage at the first electrode from a third voltage to a fourth voltage occur in a reset period.

11. The method of claim 1, wherein, when gradually reducing a voltage obtained by subtracting a voltage at the second electrode from a voltage at the first electrode from a first voltage to a second voltage, the positive wall charges are formed to the first electrode and the negative wall charges are formed to the second electrode.

12. The method of claim 11, wherein, when applying a gradually rising voltage to the first electrode, a discharge is first generated between the first electrode and the second electrode and another discharge is generated between the first electrode and the third electrode.

13. A plasma display comprising:
a first substrate;
a plurality of first electrodes and a plurality of second electrodes formed on the first substrate in parallel;
a second substrate facing the first substrate with a gap therebetween;
a plurality of third electrodes crossing the first electrodes and the second electrodes and formed on the second substrate; and
a driving circuit for supplying a driving voltage to the first electrode, second electrode, and third electrode in order to discharge a discharge cell formed by the first electrode, the second electrode, and the third electrode neighboring each other, and
wherein the driving circuit gradually reduces a voltage obtained by subtracting a voltage at the second electrode from a voltage at the first electrode from a first voltage to a second voltage, applies a gradually rising voltage to the first electrode, and gradually reduces the voltage obtained by subtracting the voltage at the second electrode from the voltage at the first electrode from a third voltage to a fourth voltage, and
the second voltage is substantially less than the fourth voltage.

14. The plasma display of claim 13, wherein the driving circuit discharges a discharge cell to be selected among the discharge cells in an address period, and sustain-discharges the selected cell in the sustain period, and
a voltage obtained by subtracting a voltage at the third electrode from a voltage at the first electrode is substantially reduced from a fifth voltage to a sixth voltage while the voltage obtained by subtracting the voltage at the second electrode from the voltage at the first electrode is gradually reduced from the third voltage to the fourth voltage, and the sixth voltage is substantially less than a negative value of a voltage corresponding to a half value of a difference between voltages applied to the first electrode and the second electrode for sustain-discharging in the sustain period.

15. The plasma display of claim 14, wherein the sixth voltage is substantially less than a negative value of a voltage corresponding to the difference between the voltages applied to the first electrode and the second electrode for sustain-discharging in the sustain period.

16. The plasma display of claim 14, wherein the sixth voltage is substantially less than a negative value of a discharge firing voltage between the first electrode and the third electrode.

17. A method for driving a plasma display panel having a scan electrode, sustain electrode and address electrode, comprising:
in a pre-reset period before a reset period, applying a first falling ramp voltage to the scan electrode while the sustain electrode is biased at a predetermined voltage to accumulate positive wall charges and negative wall charges in the scan electrode and the sustain electrode respectively;
in a reset period, applying first a gradually rising ramp voltage to the scan electrode and then applying a second falling ramp voltage to generate discharges in discharge cells; and
in an address period following the reset period, establishing a difference between voltages applied to an address electrode and to a scan electrode in a discharge cell to be selected to be greater than a maximum discharge firing voltage.
